(19) United States
(12) Patent Application Publication
(10) Pub. No.: US 2017/0358226 A1
(43) Pub. Date: Dec. 14, 2017

(54) METHOD AND DEVICE FOR ASSISTING IN THE PILOTING OF AN AIRCRAFT IN THE APPROACH TO A LANDING RUNWAY WITH A VIEW TO A LANDING

(71) Applicant: Airbus Operations S.A.S., Toulouse (FR)

(72) Inventors: Colin Hodges, Tournefeuille (FR); Charles Renault Leberquer, Toulouse (FR)

(73) Assignee: Airbus Operations S.A.S., Toulouse (FR)

(21) Appl. No.: 15/614,878

(22) Filed: Jun. 6, 2017

(30) Foreign Application Priority Data
Jun. 14, 2016 (FR) 16 55499

(51) Int. Cl. G08G 5/02; G05D 1/00; G06T 7/20

(52) U.S. Cl. CPC G08G 5/025; G06T 7/20; G05D 1/0061; G06T 2207/30241

(57) ABSTRACT

A device includes a unit for defining evaluation criteria relating to the aircraft and to its flight, a unit for predicting an energy status of the aircraft at the end of a given segment of a flight trajectory, a unit for verifying whether at least one event will occur on the given segment, and a unit for identifying at least one action to be performed on given segment and the position where this action must be performed on this segment, the purpose of an action being to generate a change of flight configuration of the aircraft leading to a modification of the energy of said aircraft. The device is configured to form a predicted energy trajectory, from a current position of the aircraft to the end of the flight trajectory, the predicted energy trajectory indicating all identified actions and positions along the flight trajectory where these actions must be performed.

### FIELD OF THE INVENTION

The present invention relates to a method and a device for assisting in the piloting of an aircraft in an aircraft approach phase, with a view to a landing on a landing runway of an airport.

### BACKGROUND OF THE INVENTION

It is known that, in an approach phase, the crew of an aircraft, in particular of a transport airplane, must obtain, in accordance with international recommendations, a stabilized status of the aircraft at a specific point of the approach (stabilization target) which is generally set at 1000 feet above the landing runway threshold.

To be in a stabilized state, the aircraft has to be in a so-called landing configuration, the control of the thrust must be adapted to the landing configuration, the vertical speed must not be excessive, and all the checks must be carried out. In this context, the landing configuration refers to the following situation: the landing gear is extended, the flaps are extended in a landing position and the air brakes are retracted.

It will be noted that a modern flight management system makes it possible to generate a flight plan of the aircraft on which it is mounted, using published approach databases. However, such a flight plan represents to the crew only a static description of what the aircraft proposes to fly. Also, even with the assistance of an automatic piloting system or of an automatic thrust management system, the crew must determine the exact moment for changing the positions of the flaps, for lowering the landing gear and for deploying the air brakes, that is to say for modifying the flight configuration of the aircraft, in the approach.

To do this, the crew has to mentally predict the rate of deceleration on a variable vertical trajectory and ensure that control devices are not deployed outside of their speed envelope.

When the aircraft is stabilized, the crew ensures that the aircraft remains at a so-called approach speed and monitors any loss of stability until the aircraft reaches the runway threshold. If the aircraft is not stabilized at the stabilization target, or becomes unstable, the crew must initiate a go-around with a failure of the approach procedure.

Consequently, if the crew applies an excessive energy loss rate, the aircraft will have to use a surplus of fuel to be able to reach the target stabilization point at the right speed.

On the other hand, if an inadequate energy loss rate is applied to the aircraft, it will reach the target stabilization point with excessive energy and will be forced to initiate a go-around with a failure of the approach procedure.

Consequently, such standard management of the energy loss of the aircraft on approach in the landing phase is not therefore completely satisfactory, notably for crew workload and non-optimal precision reasons.

### BRIEF SUMMARY OF THE INVENTION

An aspect of the present invention may remedy this drawback. It relates to a method for assisting in the piloting of an aircraft in an approach to a landing runway with a view to a landing, said aircraft being able to be brought into one of a plurality of different flight configurations.

According to an aspect of the invention, said method comprises:
a definition step, implemented by a criteria definition unit and consisting in defining evaluation criteria relating to the aircraft and to its flight;
a prediction step, implemented by a prediction unit and consisting in predicting an energy status of the aircraft at the end of a given segment of said flight trajectory as a function at least of the flight configuration of the aircraft at the start of the segment;
a verification step, implemented by a verification unit and consisting in verifying whether at least one event will occur on said given segment;
an identification step, implemented by an identification unit and consisting in identifying, if necessary, at least one action to be performed on said given segment and the position where the action must be performed on this segment, the purpose of an action being to generate a change of flight configuration of the aircraft leading to a modification of the energy of said aircraft,

the prediction, verifying and identification steps being implemented, segment by segment, from a current segment to the end of the flight trajectory so as to obtain a predicted energy trajectory, from a current position of the aircraft to the end of the flight trajectory, the predicted energy trajectory indicating, if necessary, the identified actions and the positions along the flight trajectory where these actions must be performed.

Thus, by virtue of the present invention, a predicted energy trajectory is automatically determined which defines all the actions to be performed and the positions along the flight trajectory where these actions must be performed to obtain an appropriate reduction of the energy of the aircraft in landing. Preferably, said method allows the aircraft to reduce its energy in a controlled manner during the approach until it reaches, as flight configuration, a standard target landing configuration. The assistance, thus provided to the crew, makes it possible to remedy the abovementioned drawback.

In the context of the present invention, the flight configuration of the aircraft takes into account at least one of the following parameters:
at least one position of at least one flap of the aircraft;
at least one position of at least one landing gear of the aircraft;
at least one position of at least one air brake of the aircraft;
a controlled speed target,

and an action has the effect of modifying at least one of these parameters.

Advantageously, the definition step consists in defining an acceptable energy corridor for the aircraft, said energy corridor illustrating the total energy and being defined along a flight trajectory comprising a plurality of successive segments.

Moreover, advantageously, the method comprises, between the definition step and the prediction step, a computation step implemented by a computation unit and consisting in determining the total height of the aircraft at an initial position and in applying the evaluation criteria relating to the aircraft and to its flight.

Advantageously, the evaluation criteria comprise at least one of the following criteria:
a criterion based on a flight configuration of the aircraft;
a criterion relating to a total height of the aircraft;
a criterion relating to a height of the aircraft;
a criterion relating to a speed of the aircraft;
a criterion relating to a position of the aircraft;
at least one criterion combining a plurality of the preceding criteria.

In a particular embodiment, the prediction step consists in predicting the trend of the energy, at the end of a given segment of said flight trajectory, as a function also of wind conditions.

Moreover, advantageously, the implementation of said method is triggered in at least one of the following ways:
repetitively;
when at least one event relating to the flight of the aircraft occurs.

Advantageously, the method further comprises at least one piloting step, implemented by at least one piloting assistance unit and consisting in assisting in implementing, on the aircraft, the actions defined on the predicted energy trajectory at the corresponding positions, in the approach.

The present invention relates also to a device for assisting in the piloting of an aircraft in an approach to a landing runway with a view to a landing.

According to an embodiment of the invention, said device comprises:
a definition unit configured to define evaluation criteria relating to the aircraft and to its flight;
a prediction unit configured to predict an energy status of the aircraft at the end of a given segment of said flight trajectory as a function at least of the flight configuration of the aircraft at the start of the segment;
a verification unit configured to verify whether at least one event will occur on said given segment;
an identification unit configured to identify, if necessary, at least one action to be performed on said given segment and the position where the action must be performed on this segment, the purpose of an action being to generate a change of flight configuration of the aircraft leading to a modification of the energy of said aircraft,

the prediction, verifying and identification units being configured to implement their processing operations, segment by segment, from a current segment to the end of the flight trajectory so as to obtain a predicted energy trajectory, from a current position of the aircraft to the end of the flight trajectory, the predicted energy trajectory indicating, if necessary, the identified actions and the positions along the flight trajectory where these actions must be performed.

Furthermore, advantageously, the device also comprises a trigger unit configured to trigger said device in at least one of the following ways:
repetitively;
when at least one event relating to the flight of the aircraft occurs.

Moreover, advantageously, the device comprises a computation unit configured to apply evaluation criteria relating to the aircraft and to its flight.

Moreover, in a first particular embodiment, the prediction, verifying and identification units are incorporated in a single central processing unit.

Furthermore, in a second particular embodiment, the prediction, verifying and identification units are incorporated in a plurality of central processing units.

Moreover, advantageously, the device comprises at least one of the following piloting assistance units, configured to assist in implementing, on the aircraft, in the approach, the actions defined on the predicted energy trajectory, at the corresponding positions:
an automatic piloting system for automatically implementing at least one of said actions;
a display unit for displaying, on at least one screen, at least one indication making it possible to indicate to a pilot of the aircraft at least one of said actions.

The present invention relates also to an aircraft, in particular a transport airplane, which is provided with a piloting assistance device such as that described above.

### BRIEF DESCRIPTION OF THE DRAWINGS

The attached figures will give a good understanding as to how the invention can be produced. In these figures, identical references designate similar elements. More particularly:

FIG. 1 is the block diagram of a particular embodiment of a piloting assistance device;

FIG. 2 is a graph showing a flight trajectory;

FIG. 3 is a graph illustrating a predicted energy trajectory determined by the piloting assistance device of FIG. 1; and

FIG. 4 is the block diagram of successive steps of the method, implemented by the piloting assistance device of FIG. 1.

### DETAILED DESCRIPTION

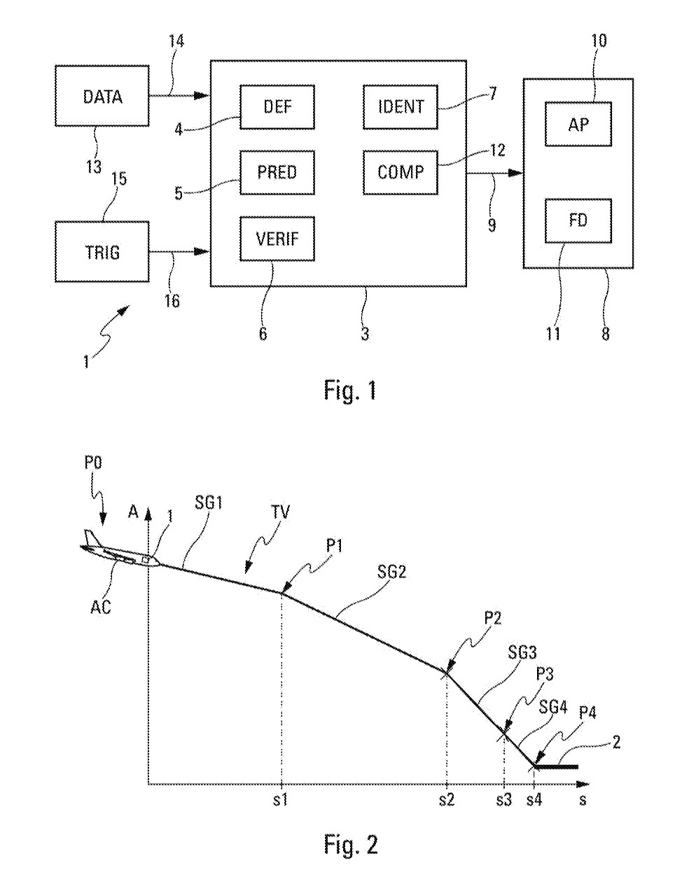

The device 1 used to illustrate an embodiment of the invention and represented schematically in FIG. 1, is a piloting assistance device of an aircraft AC (FIG. 2), in particular of a transport airplane, in an approach with a view to a landing.

In such an approach, the aircraft AC flies along a flight trajectory TV. This flight trajectory TV is defined from a flight plan and comprises a plurality of successive segments SG1, SG2, SG3 and SG4, as represented in FIG. 2. In this FIG. 2, which is a graph illustrating the altitude A as a function of a horizontal distance s along the flight trajectory, the aircraft AC is located at a current position P0 (to which the segment SG1 is linked) and will meet up with a target stabilization point P3 at a distance s3, before the landing on a landing runway 2 of an airport, the threshold of which is shown by a point P4 of distance s4. For this, the aircraft flies along successive segments SG1, SG2, SG3 and SG4 ending respectively at points P1, P2, P3 and P4 of respective distances s1, s2, s3 and s4.

Said device 1 comprises, as represented in FIG. 1, a processing set 3 (or central processing unit) comprising:
a criteria definition unit 4 (“DEF” for “definition unit”) configured to define a plurality of evaluation criteria, specified hereinbelow, including for example two high and low energy criteria forming an energy corridor defining an acceptable energy for the aircraft in the approach;
a prediction unit 5 (“PRED” for “prediction unit”) configured to predict an energy status of the aircraft, at the end of a given segment of said flight trajectory, as a function at least of the flight configuration of the aircraft at the start of this segment;
a verification unit 6 (“VERIF” for “verification unit”) configured to verify whether at least one event will occur on said given segment; and
an identification unit 7 (“IDENT” for “identification unit”) configured to identify, if necessary, at least one action to be performed on said given segment and the position where the action must be performed on this segment.

In the context of the present invention, the aim of an action is to generate a change of flight configuration of the aircraft leading to a modification of the energy of said aircraft.

Said prediction 5, verification 6 and identification 7 units are configured to implement their processing operations (prediction, verification, identification), segment by segment, from a current segment to the end of the flight trajectory so as to obtain a predicted energy trajectory, from a current position P0 of the aircraft to the end of the flight trajectory, for example to the threshold P4 of the landing runway.

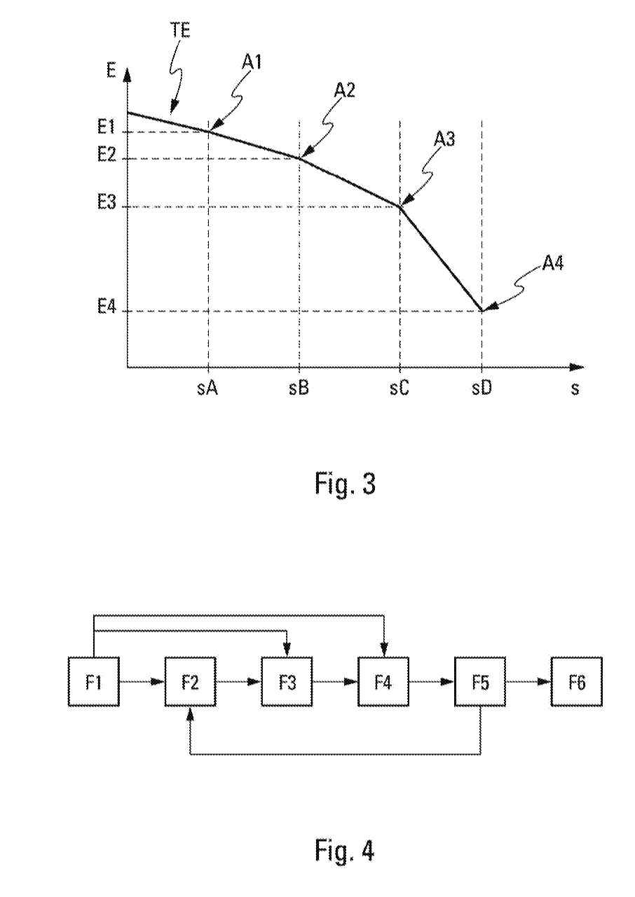

The predicted energy trajectory TE indicates the actions A1, A2, A3 and A4 identified and the positions along the flight trajectory where these actions A1, A2, A3 and A4 must be performed, as illustrated partially by way of nonlimiting example in FIG. 3. This FIG. 3 shows a graph which illustrates the total energy E of the aircraft as a function of a horizontal distance s along the flight trajectory. In this particular case, the actions A1, A2, A3 and A4 must be performed, respectively, at distances sA, sB, sC and sD where the aircraft exhibits total energies E1, E2, E3 and E4.

Thus, the device 1 which is embedded on the aircraft (FIG. 2) determines, automatically, a predicted energy trajectory TE which defines all the actions A1 to A4 to be performed, and the positions along the flight trajectory where these actions A1 to A4 must be performed, to obtain an appropriate reduction of the total energy E of the aircraft in the approach with a view to the landing.

In a preferred application, the device 1 allows the aircraft to reduce its energy in a controlled manner during the approach until it reaches, as flight configuration, a standard target landing configuration.

In the context of the present invention, the flight configuration of the aircraft takes into account at least one of the following parameters:
at least one position of at least one flap of the aircraft;
at least one position of at least one landing gear of the aircraft;
at least one position of at least one air brake of the aircraft;
a controlled speed target.

Furthermore, it is considered that an action A1 to A4 (which can be manual or automatic) has the effect of modifying one of these parameters, in order to modify the total energy of the aircraft, and more particularly to reduce the total energy in the landing.

Moreover, the device 1 comprises a set 8 comprising one or a plurality of piloting assistance units, which is linked via a link 9 to the processing set 3. These piloting assistance units are configured to assist in implementing, on the aircraft, the actions defined on the predicted energy trajectory, when the aircraft arrives at the corresponding positions during its flight in the approach.

More particularly, the set 8 can comprise:
an automatic piloting system 10 (“AP” for “automatic pilot”) which receives at least some of the actions via the link 9 and implements them automatically when the aircraft arrives at the associated positions; and
a display system 11, such as a flight director (“FD” for “flight director”) for example, which receives at least some of the actions via the link 9 and displays, on at least one screen of the cockpit of the aircraft, at least one symbol making it possible to indicate to a pilot of the aircraft these actions and their associated positions. In this case, the pilot can perform these actions manually.

The device 1 further comprises a computation unit 12 (“COMP” for “computation unit”) which is incorporated in the processing set 3 and which is configured to apply evaluation criteria relating to the aircraft and to its flight, as specified hereinbelow.

The evaluation criteria comprise at least some of the following criteria:
a criterion based on a flight configuration of the aircraft;
a criterion relating to a total height of the aircraft;
a criterion relating to a height of the aircraft;
a criterion relating to a speed of the aircraft;
a criterion relating to a position of the aircraft; and
at least one criterion combining a plurality of the preceding criteria.

In the context of the present invention, a plurality of criteria can be used together. Furthermore, by using together a high energy criterion and a low energy criterion, an energy corridor can be created.

In one embodiment, the units 4, 5, 6, 7 and 12 are implemented in the form of software functions of the processing set 3.

The device 1 also comprises a set 13 of information or data sources (“DATA” for “data generation set”), comprising, for example, a flight management system, a positioning means and/or an inertial unit. This set 13 supplies a dataset, such as, for example, a flight plan, and the current values of parameters (position, speed, altitude, etc.) of the aircraft, to the processing set 3 via a link 14.

The device 1 further comprises a trigger unit 15 (“TRIG” for “trigger unit”) configured to trigger, via a link 16, the implementation of the predicted energy trajectory computation method, performed by the processing set 3. This trigger unit 15 is configured to perform the triggering in at least one of the following ways:
repetitively, that is to say at successive time intervals, virtually continuously; and/or
when at least one event relating to the flight of the aircraft occurs, for example when the aircraft changes flight configuration or else when the aircraft deviates significantly from its flight plan.

Moreover, in a first simplified embodiment, the computation, prediction, verification and identification units are incorporated in one and the same central processing unit, of CPU (“central processing unit”) type, which has a sufficient computation power.

Furthermore, in a second particular embodiment, the computation, prediction, verification and identification units are incorporated in a plurality of different central processing units, which for example exhibit reduced computation powers. In this case, the prediction of each segment can be implemented in separate CPU computation cycles. Low-power CPU processing units can implement a single segment per CPU computation cycle, whereas high-power CPU processing units can implement predictions on different segments to reach a result more rapidly.

The device 1 uses a target trajectory of the aircraft to the landing runway, comprising a target speed profile.

The device 1, as described above, thus offers notably the following advantages, as specified hereinbelow:
it makes it possible to provide an effective strategy for controlling (reducing) the energy of the aircraft to the landing. This can be obtained by an automatic control of the aircraft, via the automatic piloting system 10 (FIG. 1) or by supplying appropriate information to the crew, via the display system 11;
it allows numerous criteria to be taken into account extremely flexibly, making it possible to manage a wide variety of unusual operational cases; and
it is simple to implement and does not require multiple iterations to adapt and converge toward a solution. By virtue of this simplicity of the computation means, the device 1 can be implemented on low-power avionics units.

The device 1, as described above, implements, automatically, the following series of steps, of the method represented in FIG. 4 (in conjunction with the elements of the device 1 shown in FIG. 1):
a step F1 of definition of evaluation criteria, as specified hereinabove, implemented by the criteria definition unit 4. These evaluation criteria are used by the steps F2, F3 and F4 specified hereinbelow. Out of the plurality of possible evaluation criteria, the step F1 notably makes it possible to define a low energy value and a high energy value, making it possible to define an acceptable energy corridor for the aircraft. The energy corridor illustrates the total energy of the aircraft and is defined along a flight trajectory comprising a plurality of successive segments;
a computation step F2, implemented by the computation unit 12 and consisting in determining the total height of the aircraft at an initial position and in applying evaluation criteria relating to the aircraft and to its flight;
a prediction step F3, implemented by the prediction unit 5 and consisting in predicting a trend of the energy at the end of a given segment of the flight trajectory as a function at least of the flight configuration of the aircraft at the start of this given segment;
a verification step F4, implemented by the verification unit 6 and consisting in verifying whether at least one particular event (forming part of a plurality of predetermined events) will occur on said given segment; and
an identification step F5, implemented by the identification unit 7 and consisting in identifying, if necessary, at least one action to be performed on said given segment, and the position on this segment where this action must be performed.

If the identification step F5 identifies that an action must be performed, it subdivides the segment at the position where this action must be performed. The next iteration will begin at this position. Thus, the positions where the actions are performed are not necessarily the waypoints of the flight plan used.

The abovementioned series of steps uses as input a flight trajectory which is defined, in a prior step, in the usual manner, from this flight plan.

The computation, prediction, verification and identification steps F2 to F5 are implemented, segment by segment, from a current segment to the end of the flight trajectory in order to generate the predicted energy trajectory. The predicted energy trajectory is thus generated from the current position P0 of the aircraft AC to the end of the flight trajectory at the point P3 or at the point P4 (FIG. 2). The predicted energy trajectory indicates all the identified actions, and the positions along the flight trajectory where these actions must be performed.

Through the implementation of these steps F1 to F5, the device 1 therefore identifies the necessary actions of thrust control, and of extension of the landing gears, of the flaps and of the air brakes, to allow the aircraft to reduce its energy in a controlled manner during the approach until it reaches the target landing configuration, at the point P3.

The device 1 also performs a piloting step F6. This piloting step F6 is at least partially implemented by one of the units 10 and 11 and consists in assisting in implementing, on the aircraft, the defined actions on the predicted energy trajectory at the corresponding positions, during the flight of the aircraft during the approach.

The device 1 therefore implements a forward prediction to evaluate, sequentially, the energy status of the aircraft with a segment of the flight plan, and to determine whether an action (flaps extended/retracted, landing gear extended/retracted, air brakes extended/retracted, thrust applied or not) must be implemented and its associated position on the segment. If an action is required, the method is repeated on the part of the segment remaining to identify other actions. This prediction continues along the flight plan, until the end of the flight plan (namely the threshold P4 of the landing runway).

The Boolean logics implemented by the device 1 and specified hereinbelow, are such that the condition or the criterion evaluated can take only two values 1 (true) or 0 (false), that is to say can be realized or not. The Boolean logics are applied in step F5 by using the true/false statuses generated by the steps F2, F3 and F4. Since many evaluation criteria are usually taken into account, the steps F2, F3 and F4 will supply several Boolean datasets.

Said steps F1 to F5 are presented hereinbelow in more detail.

In step F1, a plurality of evaluation criteria are defined. An important criterion concerns the acceptable speed for extending the landing gears. Another important criterion concerns an energy corridor defined for the acceptable minimum and maximum energies of the aircraft along the flight plan. This energy corridor is obtained by taking into account the following three substeps.

In a first substep, a path is defined in a three-dimensional space, linked to the current position of the aircraft and to the threshold of the runway by a series of waypoints. The first waypoint is defined at the current position of the aircraft to link the aircraft to the landing runway. Each of the waypoints is associated with a target altitude and a target speed. The waypoints comprise a target stabilization position and an associated target approach speed. Between each waypoint, the lateral trajectory is considered to be a straight line segment or a curved segment with constant radius with an associated center position.

Furthermore, between each succession of two waypoints, the vertical trajectory has a constant slope.

Then, in a second substep, a 2D trajectory (distance to the runway, altitude) is generated from the 3D trajectory of the aircraft. Since the aircraft requires a turn radius to change heading between two successive segments, this representation includes an adjustment of the turn radius using the target speed at the waypoint.

Finally, in a third substep, the trajectory is represented in total energy terms, from the 2D flight trajectory of the aircraft and from the associated speed profile.

The total energy E_{T} is the sum of the potential gravitational energy E_{P} of the aircraft and the kinetic energy E_{C} of the aircraft:

$${E}_{T} = {E}_{P} + {E}_{C}$$

$${E}_{T} = mgh + \frac{1}{2} m {V}_{a}^{2}$$

This equation can be simplified by considering that the mass m of the aircraft remains constant during the approach, g being the acceleration of gravity, and by rewriting it to express the status of the aircraft in terms of specific total height:

$$\frac{{E}_{T}}{m g} = {h}_{T} = h + \frac{1}{2 g} {V}_{a}^{2}$$

Thus, the target altitude h and the target air speed Vₐ can be expressed by a specific total height h_{T} for each point along the flight path.

In the context of the present invention, the method can be implemented on the basis of the total energy or of the total height, which are two equivalent concepts.

Moreover, in the computation step F2, the current instantaneous total height of the aircraft is determined at the initial position and Boolean values (either 0 (false), or 1 (true)) are determined on the basis of a set of criteria. These criteria can be:
based on the flight configuration, for example landing configuration, of the aircraft;
related to the total height h_{T}; (for example the aircraft is under or at the total stabilization height);
relative to the height (for example the aircraft is under or at the stabilization height);
relative to the speed (for example the aircraft is under the maximum speed limit for deployment of the landing gear);
relative to the position (for example the aircraft is at least at a predetermined distance from the threshold of the landing runway; and
relative to the combination of several of these variables.

Moreover, in the computation step F3, a prediction is produced on the trend of the energy at the end of the current segment, from the current flight configuration of the aircraft (flap positions, landing gear positions, air brake positions, controlled speed target) and the available wind conditions (received from the set 13).

This prediction identifies the final energy status, by assuming that the aircraft maintains a constant slope along the segment considered and does not change flight configuration.

The prediction is produced by identifying the change of speed as a function of the distance:

$$\frac{dv}{ds} = \frac{dv}{ds} \cdot \frac{dt}{dt} = \frac{dv}{dt} \cdot \frac{dt}{ds} = \frac{a}{v}$$

$${\int }_{{v}_{0}}^{{v}_{1}} \frac{v}{a} dv = {\int }_{{s}_{0}}^{{s}_{1}} ds = {s}_{1} - {s}_{0}$$

By assuming that the acceleration is constant (a₀ at t₀), the solution can be given by a simple motion equation:

v₁²=v0²+2a₀(s₁−s₀)

a₀ is an acceleration which takes into account parameters of the aircraft, such as, for example, the mass, the center of gravity, the aerodynamic configuration, the speed, etc., and parameters of the environment of the aircraft, such as, for example, wind, temperature, etc.

This result can be used to express the trend of the total height h_{T} as a function of distance s:

$${h}_{T} ( s ) = {h}_{T 0} + γ ( s - {s}_{0} ) + \frac{{v ( s )}^{2} - {v}_{0}^{2}}{2 g} = {h}_{T 0} + γ ( s - {s}_{0} ) + \frac{2 {a}_{0} ( s - {s}_{0} )}{2 g}$$

γ is the flight path angle expressed in radians. Since the aircraft is generally descending, this value is generally negative.

The computation step F3 computes the energy at the end of the segment, and also an associated speed at the end of the segment (to estimate whether criteria linked to the speed are encountered).

In the verification step F4, by using the same assumptions as in the prediction step F3, the segment is evaluated against a list of events to determine whether these events occur or not during the flight along the segment. It is for example possible to verify whether the aircraft crosses a maximum energy limit.

If an event occurs, its position (or location) is determined. With a prediction of the trend of the energy of the aircraft during the segment and a constant slope, it is possible to determine the position where the aircraft is predicted to reach a specific speed, for example a speed V_{FE} (namely the acceptable maximum speed for a change of flap position).

Thus, by considering a segment beginning at s₀ at a height h₀, sᵢ is identified, in which:

$${h}_{T} ( {s}_{i} ) = {h}_{0} + γ ( {s}_{i} - {s}_{0} ) + \frac{{v}_{FE}^{2}}{2 g}$$

Moreover, in the identification step F5, a Boolean logic is applied to determine the appropriate action to be implemented. This action can consist in maintaining the current energy status until the end of the segment. The Boolean logic uses for this purpose:
the flight configuration of the aircraft at the start of the segment;
the Boolean criterion at the start of the segment (step F2);
the Boolean criterion at the end of the segment (step F3);
the Boolean criterion for the events occurring in the segment (step F4);
the relative position of the events occurring in the segment (step F4).

The output of this decision-making logic is:
the starting position for the next prediction step. This starting position can be situated at the end of the preceding segment or in the preceding segment;
the flight configuration of the aircraft at the next prediction step.

The decision logic must give a higher priority to observing the limitations of the flight manual than to keeping the aircraft close to the target energy profile.

The steps F2 to F5 are repeated until the end of the flight trajectory is reached. In this way, a predicted energy trajectory is created with associated geometrical positions for changes of flight configuration of the aircraft.

Through the implementation of the abovementioned method, the following advantages are thus obtained:
the prediction requires no iterative convergence to adjust the predictions. Consequently, the method is significantly faster than the methods which require iterative predictions to obtain the convergence toward a solution;
the Boolean criterion can consider multiple objectives, such as multiple energy targets, along the flight plan;
the prediction for each segment can be implemented in separate CPU processing units. For example, low-power CPU processing units can implement the processing steps (for the prediction) on a single segment per computation cycle, whereas high-power CPU processing units can implement predictions on a plurality or all of the segments to reach a result more rapidly; and
the Boolean decision logic is extremely flexible and can apply specific procedures under specific conditions (such as, for example, to not allow the use of the air brakes for certain given flap positions).

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for assisting in the piloting of an aircraft in an approach to a landing runway with a view to landing, said aircraft (AC) being able to be brought into one of a plurality of different flight configurations, said method comprising:
a definition step (F1), implemented by a criteria definition unit and including defining evaluation criteria relating to the aircraft and to its flight;
a prediction step (F3), implemented by a prediction unit and including predicting an energy status of the aircraft (AC) at the end of a given segment (SG1 to SG4) of said flight trajectory (TV) as a function at least of the flight configuration of the aircraft (AC) at the start of the segment (SG1 to SG4);
a verification step (F4), implemented by a verification unit and including verifying whether at least one event will occur on said given segment (SG1 to SG4); and
an identification step (F5), implemented by an identification unit and including identifying, if necessary, at least one action (A1 to A4) to be performed on said given segment (SG1 to SG4) and the position where the action must be performed on the given segment (SG1 to SG4), the purpose of an action (A1 to A4) being to generate a change of flight configuration of the aircraft (AC) leading to a modification of the energy of said aircraft (AC),
the prediction, verifying and identification steps (F3 to F5) being implemented, segment by segment, from a current segment to the end of the flight trajectory (TV) so as to obtain a predicted energy trajectory (TE), from a current position of the aircraft (AC) to the end of the flight trajectory (TV), the predicted energy trajectory (TE) indicating, if necessary, the identified actions (A1 to A4) and positions along the flight trajectory (TV) where these actions (A1 to A4) must be performed.

2. The method as claimed in claim 1, wherein the definition step (F1) includes defining an acceptable energy corridor for the aircraft (AC), said energy corridor illustrating the total energy and being defined along a flight trajectory (TV) comprising a plurality of successive segments (SG1 to SG4).

3. The method as claimed in claim 1, further comprising, between the definition step (F1) and the prediction step (F3), a computation step (F2) implemented by a computation unit and including applying the evaluation criteria relating to the aircraft (AC) and to its flight.

4. The method as claimed in claim 1, wherein the evaluation criteria comprise at least one of the following criteria:
a criterion based on a flight configuration of the aircraft (AC);
a criterion relating to a total height of the aircraft (AC);
a criterion relating to a height of the aircraft (AC);
a criterion relating to a speed of the aircraft (AC);
a criterion relating to a position of the aircraft (AC);
at least one criterion combining a plurality of the preceding criteria.

5. The method as claimed in claim 1, wherein the prediction step (F3) includes predicting the trend of the energy, at the end of a given segment of said flight trajectory (TV), as a function also of wind conditions.

6. The method as claimed in claim 1, wherein the flight configuration of the aircraft (AC) takes into account at least one of the following parameters:
at least one position of at least one flap of the aircraft (AC);
at least one position of at least one landing gear of the aircraft (AC);
at least one position of at least one air brake of the aircraft (AC);
a controlled speed target,
and wherein an action (A1 to A4) has the effect of modifying at least one of these parameters.

7. The method as claimed in claim 1, wherein the implementation of said method is triggered in at least one of the following ways:
repetitively;
when at least one event relating to the flight of the aircraft (AC) occurs.

8. The method as claimed in claim 1, further comprising at least one piloting step (F6) implemented by at least one piloting assistance unit and including assisting in implementing, on the aircraft (AC), the actions (A1 to A4) defined on the predicted energy trajectory (TE) at the corresponding positions, in the approach.

9. A device for assisting in the piloting of an aircraft in an approach to a landing runway with a view to a landing, said device comprising:
a criteria definition unit configured to define evaluation criteria relating to the aircraft and to its flight;
a prediction unit configured to predict an energy status of the aircraft (AC) at the end of a given segment (SG1 to SG4) of said flight trajectory (TV) as a function at least of the flight configuration of the aircraft (AC) at the start of the segment (SG1 to SG4);
a verification unit configured to verify whether at least one event will occur on said given segment (SG1 to SG4); and
an identification unit configured to identify, if necessary, at least one action (A1 to A4) to be performed on said given segment (SG1 to SG4) and the position where the action (A1 to A4) must be performed on the given segment (SG1 to SG4), the purpose of an action (A1 to A4) being to generate a change of flight configuration of the aircraft (AC) leading to a modification of the energy of said aircraft (AC),
the prediction, verifying and identification units being configured to implement their processing operations, segment by segment, from a current segment to the end of the flight trajectory (TV) so as to obtain a predicted energy trajectory (TE), from a current position of the aircraft (AC) to the end of the flight trajectory (TV), the predicted energy trajectory (TE) indicating, if necessary, the identified actions (A1 to A4) and the positions along the flight trajectory (TV) where these actions (A1 to A4) must be performed.

10. The device as claimed in claim 9, further comprising a trigger unit configured to trigger said device in at least one of the following ways:
repetitively;
when at least one event relating to the flight of the aircraft (AC) occurs.

11. The device as claimed in claim 9, further comprising a computation unit configured to apply evaluation criteria relating to the aircraft (AC) and to its flight.

12. The device as claimed in claim 9, wherein the prediction, verifying and identification units are incorporated in a single central processing unit.

13. The device as claimed in claim 9, wherein the prediction, verifying and identification units are incorporated in a plurality of central processing units.

14. The device as claimed in claim 9, further comprising at least one of the following piloting assistance units, configured to assist in implementing, on the aircraft (AC), in the approach, the actions (A1 to A4) defined on the predicted energy trajectory (TE) at the corresponding positions:
an automatic piloting system for automatically implementing at least one of said actions (A1 to A4);
a display unit for displaying, on at least one screen, at least one indication making it possible to indicate to a pilot of the aircraft at least one of said actions (A1 to A4).

15. An aircraft comprising:
a device for assisting in the piloting of an aircraft in an approach to a landing runway with a view to a landing, said device comprising:
a criteria definition unit configured to define evaluation criteria relating to the aircraft and to its flight;
a prediction unit configured to predict an energy status of the aircraft (AC) at the end of a given segment (SG1 to SG4) of said flight trajectory (TV) as a function at least of the flight configuration of the aircraft (AC) at the start of the segment (SG1 to SG4);
a verification unit configured to verify whether at least one event will occur on said given segment (SG1 to SG4); and
an identification unit configured to identify, if necessary, at least one action (A1 to A4) to be performed on said given segment (SG1 to SG4) and the position where the action (A1 to A4) must be performed on the given segment (SG1 to SG4), the purpose of an action (A1 to A4) being to generate a change of flight configuration of the aircraft (AC) leading to a modification of the energy of said aircraft (AC),
the prediction, verifying and identification units being configured to implement their processing operations, segment by segment, from a current segment to the end of the flight trajectory (TV) so as to obtain a predicted energy trajectory (TE), from a current position of the aircraft (AC) to the end of the flight trajectory (TV), the predicted energy trajectory (TE) indicating, if necessary, the identified actions (A1 to A4) and the positions along the flight trajectory (TV) where these actions (A1 to A4) must be performed.
